(19) United States
(12) Patent Application Publication
(10) Pub. No.: US 2005/0232408 A1
(43) Pub. Date: Oct. 20, 2005

(54) System for contact system entities beyond end-points to track state availability and capabilites by implementing SIP presence technologies

(76) Inventors: Jeffrey D. Hodson, Wheaton, IL (US); Mary Ellen Moser, Warrenville, IL (US); Mike Hollatz, Huntley, IL (US); Dave Wesen, Channahon, IL (US)

Correspondence Address: WELSH & KATZ, LTD, 120 S RIVERSIDE PLAZA, 22ND FLOOR, CHICAGO, IL, 60606, US

(21) Appl. No.: 10/825,570

(22) Filed: Apr. 15, 2004

(51) Int. Cl. H04M 3/00; H04M 5/00

(52) U.S. Cl. 379/265.02; 379/266.03

(57) ABSTRACT

A method and apparatus are provided for processing information within a computer system. The method includes the steps of sending a SIP SUBSCRIBE message from a first computer resource of the computer system to a presentity server of a second computer resource of the computer system requesting a status of the second resource where the second resource separately performs a predetermined service for the first resource and sending a SIP NOTIFY message from a presentity server of the second resource to the first resource notifying the first resource of the status of the second resource.

### FIELD OF THE INVENTION

The field of the invention relates to computer systems and more particularly, to automatic call distributors.

### BACKGROUND OF THE INVENTION

Automatic call distributors (ACDs) are known. Such systems are typically used by organizations to serve large numbers of callers through the Public Switched Telephone Network (PSTN). Typically, inbound calls are directed to a common telephone number of the organization and distributed to agents based upon some criteria (e.g., agent idle time).

In addition to handling inbound calls, ACDs may also process outbound calls. Typically, a controller monitors a workload of its agents. Where a workload of received calls falls below some threshold value, the controller may begin to initiate outbound calls.

In addition to placing and distributing calls, an ACD may also identify and display documents on agent terminals as an aid to processing the calls. In the case of incoming calls, the calls may be received along with dialed number identification service (DNIS) and/or automatic number identification (ANI) information. ANI may be used to identify a caller at the same instant as the call is delivered to the ACD. The controller of the ACD may use the ANI information to retrieve and display customer records on a terminal of the agent selected to handle the call at the same instant that the call is delivered to the agent.

In addition, textual information may be displayed on a terminal of the agent that guides the agent through a sales presentation. DNIS information may be used to identify an intended call target and to select an appropriate sales presentation for use by the agent based upon the intended call target.

While automatic call distributors work relatively well, they are not particularly well suited to handling Internet calls. Further, the standards that are used for processing switched circuit calls through the PSTN cannot be used within the Internet. In addition, calls routed through the Internet often rely upon routers and other support systems whose failure is difficult to detect. Because of the additional complexity of the Internet, a need exits for a method of detecting and accommodating the unavailability of support systems that process calls through the Internet.

### SUMMARY

A method and apparatus are provided for processing information within a computer system. The method includes the steps of sending a SIP SUBSCRIBE message from a first computer resource of the computer system to a presentity server of a second computer resource of the computer system requesting a status of the second resource where the second resource separately performs a predetermined service for the first resource and sending a SIP NOTIFY message from a presentity server of the second resource to the first resource notifying the first resource of the status of the second resource.

### BRIEF DESCRIPTION OF THE DRAWINGS

FIG. 1 is a block diagram of a contact distribution system in accordance with an illustrated embodiment of the invention.

### DETAILED DESCRIPTION OF THE ILLUSTRATED EMBODIMENT

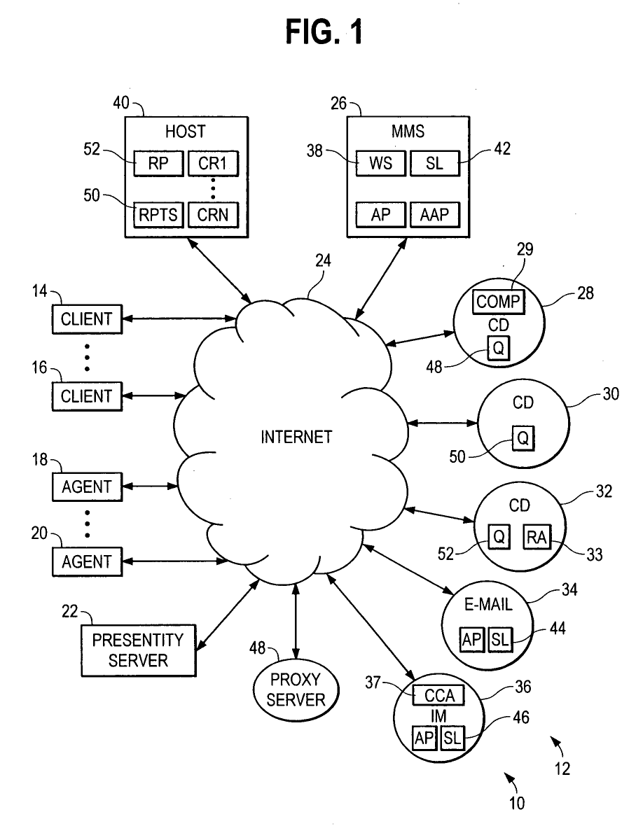

FIG. 1 is a block diagram of a contact distribution system 10 shown under an illustrated embodiment of the invention. The contact distribution system may be used for connecting calls through the Internet 24 between clients 14, 16 and agents 18, 20. In general, the system 10 may be used by any of a number of different enterprise organizations (e.g., commercial, environmental, political, etc.) to advance the agenda of the enterprise.

The system 10 may include a number of computer resources 26, 28, 30, 32, 34, 36 that function to form the connections between clients 14, 16 and agents 18, 20. Also shown in FIG. 1 is a tracking system 12 that may be used to monitor the availability of the computer resources of the system 10.

As used herein, a computer resource of the organization is a computer application or processor that processes information that is directed related to enterprise operations of the organization. Using the Open Systems Interconnection (OSI) network model, a computer resource is a user application that operates from Layer 7 of the OSI model.

As described below, at least some of the computer resources 26, 28, 30, 32, 34, 36 perform predetermined services for other computer resources in furtherance of enterprise objectives. As used herein, a predetermined service performed by one resource for another means the processing of data to achieve some enterprise result that is not directly related to communication connections through the Internet.

Access to the contact center 10 of the organization by clients 14, 16 of the organization may be provided through the Internet 14 under any of a number of different processes. In order to promulgate the agenda of the organization to its clients 14, 16, the organization may publish contact information (e.g., e-mail address, instant message (IM) address or universal resource locator (URL)), by advertising or otherwise, that identifies a communication path to the organization.

Under the illustrated embodiment, the contact distribution system 10 may include one or more servers 26, 34, 36 that may function to receive and initially process calls. A first server 34 may receive calls in the form of e-mails. A second server 36 may receive calls under an Instant Messaging (IM) format. A third multi-mode server 26 may receive calls from one or more webpages downloaded to clients 14, 16 from a website 38 of the multi-mode server 26.

In the case where the organization is a manufacturer with many different products, a different e-mail address may be provided for each different product line. As such, the e-mail server 34 may receive e-mails directed to many different addresses that are all within one or more domain names used by the e-mail server 34. The use of different destination addresses may be used to provide the system 10 with a first level indication of the call type of the received call. The IM server 36 and multi-mode server 26 may be used in a similar manner.

Calls processed by the servers 26, 34, 36 may be initiated in any of a number of different ways. For example, a call from a client 14, 16 to the multi-mode server 26 may be initiated by activation of a SPEAK WITH AGENT softkey on a webpage downloaded from the multi-mode server 26. Alternatively, calls from clients 14, 16 may by initiated in response to pop-up ads posted to websites visited by clients 14, 16. Calls may also be initiated conventionally by a client 14, 16 activating an appropriate application (e.g., Outlook by Microsoft) and entering a Universal Resource Locator (URL) of the organization under an e-mail or IM format in response to a printed ad in a newspaper or magazine.

Calls from clients 14, 16, received by the servers 26, 34, 36 may be distributed to agents 18, 20 through a number of call distributors 28, 30, 32. As the calls arrive, the server 26, 34, 36 receiving the call may open a file for each call identified by a unique call identifier. The file may include at least a source identifier (e.g., an e-mail address, URL, etc.) of the client 14, 16 originating the call and a destination identifier that identifies the call destination (e.g., e-mail address, URL, etc.) within the system 10. In the case of calls received by the multi-mode server 26, information regarding any webpages visited may also be included within the call file.

A copy of each call file may be transferred to the host 40. Within the host 40, the information within the call file may be used to identify further information about the caller. For example, the source identifier may be used to classify the call as originating from existing or new customers. Information on webpages visited or on prior contacts with the client 14, 16 may be used to provide information regarding the type of call involved.

Any additional information regarding the call may be transferred back to the server 26, 34, 36. Within the server 26, 34, 36, the information within the call file and, possibly, any additional information from the host 26 may be used within a call classification application 37 to further classify the call into one or more call types.

Once a call type has been determined, the server 26, 34, 36 may transfer the call to a call distributor 28, 30, 32. The call distributor 28, 30, 32 that the server 26, 34, 36 selects to handle the call may be based upon availability or upon the call type.

Before the server 26, 34, 36 transfers the call to a call distributor 28, 30, 32, the server 26, 34, 36 may first determine which call distributors 28, 30, 32 are available to receive calls. The server 26, 34, 36 may determine availability from a status list 42, 44, 46 that contains information on status provided by a presentity server 22.

Selection of a contact distributor 28, 30, 32 may be based simply upon status or upon some predetermined criteria. For example, the first call distributor 28 may be associated with agents 18, 20 who are primarily skilled at handling calls of a first call type and who have secondary skills in handling calls of a second type and third call type. Similarly, the second call distributor 30 may be associated with agents 18, 20 who are primarily skilled at handling calls of a second call type and who have secondary skills in handling calls of a first type and third call type and the third call distributor 32 may be associated with agents 18, 20 who are primarily skilled at handling calls of a third call type and have secondary skills in handling calls of a first type and second call type.

As such, calls of the first call type will normally be transferred to the first call distributor 28, calls of the second call type will be transferred to the second call distributor 30 and calls of the third call type will be transferred to the third call distributor 32. However, if one or more of the call distributors 28, 30, 32 is inoperative or otherwise unavailable or is overloaded, then calls may be handled by any other call distributor 28, 30, 32.

If the primary call distributor 28, 30, 32 is available, then the server 26, 34, 36 may transfer the call along with the file to the appropriate server 28, 30, 32. Within the call distributor 28, 30, 32, a call routing application 33 may compare the contents of the call file with a list of agent skills and may assign the call to a qualified agent 18, 20. If an agent is not available, then the agent selection processor may place the call in a call queue 48, 50, 52 pending availability of a qualified agent.

Turning now to the apparatus 12 for determining availability, an explanation will be provided as to how the servers 26, 34, 36 assign calls to the call distributors 28, 30, 32 based upon the status of the call distributors 28, 30, 32. In this regard, the servers 26, 34, 36 and call distributors 28, 30, 32 may interact with the tracking apparatus 12 based upon a predetermined set of Session Initiation Protocol (SIP) exchanges defined by the Internet Engineering Task Force (IETF) RFC #3261.

For example, the tracking apparatus 12 may include a presentity server 22 that has the same functionality as presentity servers defined in RFC #3261. In this regard, whenever a contact distributor 28, 30, 32 is activated, it searches for and registers its presence by sending a SIP REGISTER message to the presentity server 22 using processes defined by RFC #3261. The REGISTER message may include an expiration time period and may be periodically updated by the contact distributor 28, 30, 32.

Similarly, the servers 26, 34, 36 may send a SIP SUBSCRIBE message under RFC #3261 to the presentity server 22 identifying the contact servers 28, 30, 32 and requesting status information regarding the contact distributors 28, 30, 32. In turn, the presentity server 22 may confirm that the contact server 28, 30, 32 is registered and forward the SUBSCRIBE message to the respective contact servers 28, 30, 32 requesting a SIP NOTIFY message from the contact distributors 28, 30, 32 under RFC #3261.

In response, the contact distributors 28, 30, 32 may forward NOTIFY messages to the presentity server 22 and, ultimately, to the servers 26, 34, 36 to notify the servers 26, 34, 36 (i.e., the watcher) of any of a number of status conditions (e.g., online, offline, etc.) and status change events. For example, status change events may simply provide notification regarding the availability or unavailability of the contact distributor 28, 30, 32 or the status information may provide information regarding loading levels of the contact distributors 28, 30, 32.

With regard to loading levels, a length of a call queue 48, 50, 52 may be compared within a comparator 29 with a predetermined threshold level for each call distributor 28, 30, 32. When the queue length exceeds the threshold value, the contact distributor 28, 30, 32 may forward a NOTIFY message notifying the server 26, 34, 36 that it is unavailable for any more calls. When the queue length does not exceed the threshold value, the contact distributor 28, 30, 32 may forward a NOTIFY message notifying the server 26, 34, 36 that it is available for more calls. Alternatively, the NOTIFY message may contain an actual loading level of the call distributors 28, 30, 32.

In another illustrated embodiment of the invention, the servers 26, 34, 36 may also send SIP REGISTER messages to the presentity server 22 to register their presence within the system 10. A reports generator 50 within the host 40 may send a SIP SUBSCRIBE message to the presentity server 22 requesting the status of the servers 26, 34, 36 and contact distributors 28, 30, 32. By receiving status information, the report generator 50 is made aware of which servers 26, 34, 36 and contact distributor 28, 30, 32 are available and that have data for generating reports. Further, notification that a server 26, 34, 36 or contact distributor 28, 30, 32 is offline may itself justify the need for additional reporting data. The use of the SUBSCRIBE and NOTIFY functions of the apparatus 12 for tracking system availability allow the report generator to generate more accurate reports even in the absence of data from any particular server 26, 34, 36 or contact distributor 28, 30, 32.

In another embodiment, a reconfiguration processor 52 may subscribe to the status of the servers 26, 34, 36. In the event that the reconfiguration processor 52 should detect that a server 26, 34, 36 goes offline, the reconfiguration processor 52 may instruct a proxy server 48 to direct any calls that would have gone to the offline server 26, 34, 36 to, instead, go to one of the remaining servers 26, 34, 36.

A specific embodiment of method and apparatus for tracking the availability of resources of a computer system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of processing information within a computer system, such method comprising the steps of:
sending a SIP SUBSCRIBE message from a first computer resource of the computer system to a presentity server of the computer system requesting a status of the second resource where the second resource performs a predetermined service for the first resource;
sending a SIP NOTIFY message from the presentity server to the first resource notifying the first resource of the status of the second resource.

2. The method of processing information as in claim 1 further comprising the first resource requesting the predetermined service from a third resource when the second resource is not available.

3. The method of processing information as in claim 1 wherein the computer system further comprises an automatic call distribution system.

4. The method of processing information as in claim 3 wherein the first and second resources further comprise call distributors of the automatic call distribution system.

5. The method of processing information as in claim 4 wherein the predetermined service further routing calls to agents.

6. The method of processing information as in claim 5 wherein the requested status further comprises determining whether the second call distributor is available or unavailable.

7. The method of processing information as in claim 6 wherein the step of determining the availability of the second call distributor further comprises comparing a loading level of the second call distributor with a threshold level and determining that the second call distributor is unavailable when the loading level exceeds the threshold level and determining that the second call distributor is available when the loading level does not exceed the threshold.

8. The method of processing information as in claim 1 wherein the computer system further comprises an automatic call distributor.

9. The method of processing information as in claim 8 wherein the second resource further comprises a call routing application of the automatic call distributor.

10. The method of processing information as in claim 9 wherein the first resource further comprises a call classification application of the automatic call distributor that determines a call type of an incoming call.

11. The method of processing information as in claim 10 further comprising defining the status as being a loading level of the call routing application.

12. The method of processing information as in claim 11 further comprising defining the loading level as a call queue length.

13. The method of processing information as in claim 12 further comprising determining that the routing application is unavailable when the loading level exceeds a predetermined threshold and available when the routing application does not exceed the predetermined threshold.

14. The method of processing calls as in claim 13 further comprising the call classification application requesting the predetermined service form a third resource when the call routing application is not available.

15. An apparatus for processing information within a computer system, such apparatus comprising:
means for sending a SIP SUBSCRIBE message from a first computer resource of the computer system to a presentity server of the computer system requesting a status of the second resource where the second resource performs a predetermined service for the first resource;
means for sending a SIP NOTIFY message from the presentity server to the first resource notifying the first resource of the status of the second resource.

16. The apparatus for processing information as in claim 15 further comprising means allowing the first resource to request the predetermined service from a third resource when the second resource is not available.

17. The apparatus for processing information as in claim 15 wherein the computer system further comprises an automatic call distribution system.

18. The apparatus for processing information as in claim 17 wherein the first and second resources further comprise call distributors of the automatic call distribution system.

19. The apparatus for processing information as in claim 18 wherein the predetermined service further routing calls to agents.

20. The apparatus for processing information as in claim 19 wherein the requested status further comprises means for determining whether the second call distributor is available or unavailable.

21. The apparatus for processing information as in claim 20 wherein the means for determining the availability of the second call distributor further comprises means for comparing a loading level of the second call distributor with a threshold level and determining that the second call distributor is unavailable when the loading level exceeds the threshold level and determining that the second call distributor is available when the loading level does not exceed the threshold.

22. The apparatus for processing information as in claim 15 wherein the computer system further comprises an automatic call distributor.

23. The apparatus for processing information as in claim 22 wherein the second resource further comprises a call routing application of the automatic call distributor.

24. The apparatus for processing information as in claim 23 wherein the first resource further comprises a call classification application of the automatic call distributor that determines a call type of an incoming call.

25. The apparatus for processing information as in claim 24 further comprising defining the status as being a loading level of the call routing application.

26. The apparatus for processing information as in claim 25 further comprising defining the loading level as a call queue length.

27. The apparatus for processing information as in claim 26 further comprising means for determining that the routing application is unavailable when the loading level exceeds a predetermined threshold and available when the routing application does not exceed the predetermined threshold.

28. The apparatus for processing calls as in claim 27 further comprising a third resource that the call classification application requests the predetermined service from when the call routing application is not available.

29. An apparatus for processing information within a computer system, such apparatus comprising:
a first computer resource and a second computer resource of the computer system said first computer resource being adapted to send a SIP SUBSCRIBE message to a presentity server of the computer system requesting a status of a second resource where the second resource performs a predetermined service for the first resource;
the presentity server that sends a SIP NOTIFY message to the first resource notifying the first resource of the status of the second resource.

30. The apparatus for processing information as in claim 29 further comprising a third computer resource that the first resource requests the predetermined service from when the second resource is not available.

31. The apparatus for processing information as in claim 29 wherein the computer system further comprises an automatic call distribution system.

32. The apparatus for processing information as in claim 31 wherein the first and second resources further comprise call distributors of the automatic call distribution system.

33. The apparatus for processing information as in claim 32 wherein the predetermined service further comprises routing calls to agents.

34. The apparatus for processing information as in claim 33 wherein the requested status further comprises a call queue that determines whether the second automatic call distributor is available or unavailable.

35. The apparatus for processing information as in claim 34 wherein the call queue further comprises a comparator adapted to compare a loading level of the second call distributor with a threshold level and determining that the second call distributor is unavailable when the loading level exceeds the threshold level and determining that the second call distributor is available when the loading level does not exceed the threshold.

36. The apparatus for processing information as in claim 29 wherein the computer system further comprises an automatic call distributor.

37. The apparatus for processing information as in claim 36 wherein the second resource further comprises a call routing application of the automatic call distributor.

38. The apparatus for processing information as in claim 37 wherein the first resource further comprises a call classification application of the automatic call distributor that determines a call type of an incoming call.

39. The apparatus for processing information as in claim 38 further comprising defining the status as being a loading level of the call routing application.

40. The apparatus for processing information as in claim 39 further comprising defining the loading level as a call queue length.
